(19) United States
(12) Patent Application Publication
(10) Pub. No.: US 2022/0054960 A1
(43) Pub. Date: Feb. 24, 2022

(54) FILTERING METHOD SUITABLE FOR ISOLATING AND/OR QUANTIFYING, FROM A SAMPLE, AT LEAST ONE SUBSTANCE TO BE INVESTIGATED

(71) Applicant: Analytik Jena GmbH, Jane (DE)

(72) Inventors: Christian Paulenz, Jena (DE); Robert Möller, Jena (DE); Claus Knippschild, Jena (DE)

(21) Appl. No.: 17/413,846

(22) PCT Filed: Nov. 28, 2019
(86) PCT No.: PCT/EP2019/082858

§ 371 Date: Jun. 14, 2021

(30) Foreign Application Priority Data
Dec. 18, 2018 (DE) 10 2018 132 710.2

(51) Int. Cl. B01D 37/04; G01N 1/40

(52) U.S. Cl. CPC B01D 37/046; G01N 1/4077; B01D 2313/90; B01D 2311/14; G01N 2001/4088

(57) ABSTRACT

Disclosed is a filtering method for isolating a substance from a sample. The method includes: providing a filter module having a sample inlet, a sample outlet, and a filter covering the sample outlet; introducing, via a sample inlet a first quantity of the sample into the filter module; conducting the sample from the sample inlet through the filter and the sample outlet by applying a pressure difference between a side of the filter facing the sample inlet and a side of the filter facing away from the sample inlet; measuring the pressure difference and/or a volumetric flow through the filter; comparing the measurement values to a predefined reference value; and ending the method if successively detected measurement values lie within a predefined range of values around the reference value. Disclosed also is a device with which the method can be carried out.

The invention relates to a filtering method which can be used for isolating and/or quantifying, from a sample, a substance to be investigated. The invention also relates to a device for filtering a sample.

Many methods for enriching or isolating cells, cell constituents or macromolecular substances present in liquid samples are known in the prior art. Some of these methods are based on solid phase bonding of the substances and subsequent separation of the solid phase with the bonded substance from the other sample constituents by mechanical forces, for example by centrifugation or magnetic forces. Examples of such methods are known, for example, from EP 2 998 398 A1, DE 10 2010 031 401 A1 and DE 10 2014 211221 A1.

DE 10 2007 021 952 A1 describes a method for enriching microvesicles for the subsequent isolation of biomolecules contained in the microvesicles, in which an aqueous solution of a salt of a polyuronic acid and a substance which induces the gel formation/pellet formation of the polyuronic acid are added to the sample, the sample being centrifuged and the supernatant being removed after a short incubation time. The pellet formed during centrifugation can then be further processed and the ingredients contained in the microvesicles isolated for analysis purposes. The centrifugation time in this method should be 10 min.

Cells or cell constituents can also be separated from the other sample constituents directly, i.e. without prior solid-phase bonding, by centrifuging the sample.

Another possibility for isolating substances from samples is filtration. Like centrifugation, this belongs to the mechanical separation methods and is used in principle in many different areas. For example, filtration is used to isolate cells, cell constituents or macromolecular substances, for example bio-polymers such as polypeptides, proteins or nucleic acids from a liquid sample.

In typical filtering methods, the sample, i.e. the suspension or dispersion containing the substance to be isolated and optionally further investigated, is passed through a filter which is designed to hold back a portion of the sample and to allow the other constituents of the sample to pass through as filtrate. Depending on the application, the substance to be isolated can remain in the filter or be present in the filtrate. Many filtering methods are known from the prior art. Gravity can be used as the driving force for the transport of material through the filter. In some cases, a pressure difference is also applied between a front side and a rear side of the filter opposite the front side, so that the resulting pressure gradient existing across the filter is used for the transport of material through the filter.

DE 10 2007 021952 A1 describes a device for isolating nucleic acids from a sample solution, having two containers connected via a connecting duct. A filter consisting of a solid which adsorbs nucleic acid is arranged in the connecting duct. In each case, a positive pressure is applied to one of the containers by means of a syringe, while a negative pressure is applied to the other container by means of a further syringe in order to transport the sample solution through the filter. Nucleic acid is held back in the filter by adsorption and is thus isolated from the other constituents of the sample solution.

EP 1730 273 B1 discloses a method for the automatic isolation and purification of nucleic acid from a sample containing nucleic acid, wherein a liquid containing the sample is passed through a container which has two openings and contains a filter consisting of a solid which adsorbs nucleic acid. A pressure difference is generated between the interior of the container and its outside, which results in the liquid being conducted out of the interior of the container through the filter. A pressure prevailing in the interior of the container is measured, and a pressure change rate and a pressure change acceleration are calculated on the basis of the measured pressure. When the pressure in the interior of the container reaches a predefined value, the pressurization of the interior of the container is stopped, for example by the pump generating the pressure being turned off. The point in time at which the pressure change acceleration is minimal after the end of the pressurization is determined from pressure measurement values detected after the pump has been turned off during the continued passage of the liquid through the filter. This point in time corresponds to the point in time at which the liquid is completely discharged from the container and at which the method can be ended accordingly. The method includes provision to output an error message if the pressure change acceleration does not reach a minimum within a predefined period of time, since this is an indication that the filter is clogged.

The described separation methods known from the prior art, which are based on centrifugation or filtration, offer no possibility of checking during the ongoing process whether a quantity of the substance to be isolated sufficient for the further investigation has already been isolated. In centrifugation methods, there are frequently method specifications which must be observed exactly and which provide a certain minimum duration, based on empirical values, for centrifugation. Only after completion of the centrifugation after the prescribed minimum duration has elapsed can it be determined whether the quantity of substance obtained in the process is sufficient, for example, to carry out a subsequent analysis. If this is not the case, the method must be repeated. The same also applies to methods which comprise solid-phase adsorption or filtration. If a sample contains only a small concentration of the substance to be isolated, it may be necessary to repeat the separation method several times, which is correspondingly time-consuming. In other cases, a sufficient quantity of the substance to be isolated can already be present in the filter or in a pellet deposited during centrifugation before the predefined minimum method duration has elapsed. If this information were already available during the ongoing method, the method could in these cases be terminated in a time-saving manner at an earlier point in time without waiting for the minimum method duration.

In order to automate the method, it is also desirable to create a possibility of determining, while the separation method is being carried out, a point in time at which a certain minimum quantity of the substance has been isolated. A termination criterion for the method which can be processed by an electronic control system can be linked to reaching this point in time.

The object of the invention is therefore to specify an improved filtering method which can be used for isolating and/or quantifying a substance of a sample to be investigated. The method is intended especially to enable determination of an end point of the filtering method.

This object is achieved by the method according to claim 1 and by the device according to claim 11. Advantageous embodiments are indicated in the dependent claims.

The filtering method according to the invention for isolating and/or quantifying, from a sample, a substance to be investigated comprises:
introducing, via a sample inlet, a first quantity of the sample into a filter module which has a housing with a first opening forming the sample inlet and a second opening which is covered by a filter and forms a sample outlet, wherein the filter is designed to hold back a first portion of the sample and to allow a second portion of the sample to pass through;
conducting the sample from the sample inlet through the filter and the sample outlet by applying a pressure difference between a side of the filter facing the sample inlet and a side of the filter facing away from the sample inlet, wherein the second portion of the sample leaves the filter module through the sample outlet as a filtrate;
while the sample is being conducted from the sample inlet through the filter to the sample outlet, detecting a series of temporally sequentially recorded measurement values of a measurement variable which represents the pressure difference and/or a volumetric flow through the filter;
comparing the measurement values to a predefined reference value of the measurement variable; and
ending the filtering method if successively detected measurement values of the measurement variable, over a predefined timespan, are equal to the reference value and/or lie within a predefined range of values around the reference value.

By detecting a series of temporally sequentially recorded measurement values, a time curve of the pressure difference existing across the filter or of the volumetric flow can be monitored by the filter. If the measurement variable which represents the pressure difference and/or the volumetric flow through the filter, i.e., e.g., the pressure difference, the volumetric flow or a measurement variable which correlates with the pressure difference or the volumetric flow, especially which is dependent on the pressure difference or the volumetric flow, reaches the reference value and remains substantially constant at this reference value for a predefined timespan, so that the successively detected measurement values lie within the predefined value range (tolerance range) around the reference value, this forms the termination criterion for the filtering method. When the termination criterion is met, the method can be ended and the isolated substance further processed.

The presence of the termination criterion is an indicator that the filter has reached a state corresponding to the reference value. This state can consist, for example, in that the filter with the first portion of the sample held back therein is no longer permeable to the second portion of the sample. For example, a fluid volumetric flow of zero or near zero through the filter is an indicator that the filter is clogged by the held back first portion of the sample, the filter cake. The condition that this state is achieved is that a minimum substance quantity, determined inter alia by the type of the first portion of the sample and by the nature and size of the filter, of the first portion of the sample is held back in the filter. If the measurement variable represents the fluid volumetric flow through the filter, a volumetric flow of zero may correspondingly be predefined as the reference value. If the measurement variable reaches the reference value and retains this value for a certain minimum timespan, specifically the aforementioned timespan specified for the method, it is ensured that this minimum substance quantity of the first portion of the sample is present in the filter. Ending the method only after this termination criterion has been met thus ensures that a minimum quantity of the substance to be isolated has been obtained.

This applies both in the case in which the substance to be isolated is present in the first portion of the sample held back in the filter and in the case in which the substance to be isolated is present in the filtrate. In the latter case, the method conditions, especially the nature of the filter and the applied pressure difference, can be designed on the basis of empirical values or preliminary examinations such that a sufficient quantity of filtrate and the substance to be isolated present therein is present at the point in time at which the filter is completely clogged by the first portion of the sample.

The clogging of the filter during the ongoing filtration can be detected by monitoring the measurement variable as to whether it reaches the termination criterion. If the sample contains a high concentration of the substance to be isolated, it is not necessary to wait for a minimum filtering duration. Rather, the method can be ended after the termination criterion has been reached, which can mean a considerable time saving. If the sample contains a very low concentration of the substance to be isolated, it can happen that even within a predefined minimum filtering duration, there is still not a sufficient quantity of the substance to be isolated in the filter. Because the method is not ended after the minimum filtering duration has elapsed, but only after the termination criterion has been reached, a situation, in which a filtration process which has not produced a sufficient quantity of substance to be isolated within the minimum filtering duration has to be repeated, can be avoided.

At the same time, the method allows quantification or semi-quantification of the substance of interest. Preliminary examinations and calibration measurements can be used to determine the minimum substance quantity of the first portion of the sample required to reach the termination criterion. Based on this minimum quantity of substance and the volume or mass of the sample used, a content of the first portion of the sample in the entire sample, for example a mass fraction or volume fraction or a concentration, can be determined for samples of unknown compositions. This, in turn, is a quantitative measure of a concentration, a mass fraction or a volume fraction of the substance in the sample.

The reaching of the termination criterion can be monitored by an electronic control system on the basis of the measurement values. This allows the method to be carried out automatically.

In one embodiment, the filter can be a size exclusion filter. In another embodiment, the filter can be a solid which adsorbs the first portion of the sample, wherein the solid has pores which are permeable to the second portion of the sample or comprises a bed of solid particles between which the second portion of the sample can be passed through the bed.

In an advantageous embodiment, the reference value can be the value which the measurement variable assumes when the filter is clogged by the first portion of the sample such that the second portion of the sample and/or a fluid introduced into the housing for pressure generation no longer passes through the filter.

In one possible embodiment, the substance to be investigated can be present in the first portion of the sample held back by the filter. In a special case of this embodiment, this first portion of the sample can be identical to the substance to be investigated. If the substance to be investigated is present in the first portion of the sample, the method can comprise the following further steps: After the filtering method has ended, the substance to be investigated is obtained from the first portion of the sample held back in the filter module by the filter as filter cake. In the special case that the entire first portion of the sample is the substance to be investigated, obtaining the substance to be investigated comprises mechanically detaching and/or washing out the substance from the filter. In other cases, it is possible to remove the first portion of the sample from the filter first and then purify or prepare it further. In some cases, the filter cake can be eluted directly from the filter by lysis.

If the termination criterion is reached, any liquid remaining in the filter module upstream of the filter can be pipetted off before the substance to be investigated is obtained from the first portion of the sample held back in the filter.

In another embodiment, the substance to be investigated can be present in the filtrate, that is to say the second portion of the sample. In this case, the filtrate produced during the filtering is collected in a collection container connected to the filter module and optionally further processed to investigate the substance.

If the second portion of the sample substantially completely leaves the filter module before successively detected measurement values of the measurement variable, over the predefined timespan, are equal to the reference value and/or lie within the predefined range of values around the reference value, a second quantity of the sample is introduced via the sample inlet into the filter module and conducted from the sample inlet through the filter and the sample outlet. These steps can be repeated until successively detected measurement values of the measurement variable, over the predefined timespan, are equal to the reference value and/or lie within the predefined range of values around the reference value.

In one possible embodiment, the filter module can be connected to a collection container for the second portion of the sample, wherein the collection container has an opening which can be connected to the filter module, and wherein the second opening, covered by the filter, in the housing of the filter module is aligned with the opening of the collection container when the collection container is connected to the filter module.

The pressure difference can be applied by means of a pressure control device cooperating with the filter module to set a pressure prevailing in the housing.

The pressure control device can be configured to generate a positive pressure in the housing of the filter module. Where reference is made here and below to the generation or setting of a positive pressure or a negative pressure, a positive pressure or a negative pressure relative to the prevailing normal pressure is meant. Under normal conditions, the normal pressure is defined as the mean air pressure of the atmosphere at sea level and is, for example, approximately 1 bar. In this case, the measurement variable can be a pressure prevailing in the housing of the filter module or a variable dependent on the pressure prevailing in the housing of the filter module, and the reference value can be a pressure setpoint value or a setpoint value of the variable dependent on the pressure.

Additionally or alternatively, the pressure control device can cooperate with the collection container to set a pressure prevailing in the collection container for the second portion of the sample. For example, it can be configured to generate a negative pressure in the collection container. In this case, the measurement variable can be a pressure prevailing in the collection container or a variable dependent on the pressure prevailing in the collection container, and the reference value can be a pressure setpoint value or a setpoint value of the variable dependent on the pressure.

In all these embodiments, the pressure control device can have a control unit, especially an electropneumatic control unit, wherein the measurement variable is an output pressure output by the control unit or a variable correlating with the output pressure, and the reference value is an input pressure of the control unit or a variable correlating with the input pressure. The input pressure of the control unit can have a value representing the pressure setpoint value to be set in the housing of the filter module or the collection container.

The control unit can be an electropneumatic regulator, for example. In this case, the mentioned variable correlating with the output pressure can be an output current of the electropneumatic regulator. Accordingly, the mentioned variable correlating with the input pressure can be an input current of the electropneumatic regulator.

The measurement variable can also be a filtrate volumetric flow and/or air volumetric flow through the filter or a variable representing a filtrate volumetric flow and/or air volumetric flow through the filter, and the reference value can be a volumetric flow value of zero.

The substance can be a particle type present in the sample, a cell type, cell constituents or a molecular, especially macromolecular, substance. The sample can be a suspension or a dispersion.

If the pressure difference is applied as described above by means of a pressure control device cooperating with the filter module to set a pressure prevailing in the housing, the positive pressure prevailing in the housing can be reduced by means of the pressure control device before the housing is opened to remove the filter cake and/or before a second quantity of the sample is applied. It is also advantageous when pressurizing the housing with positive pressure by means of the pressure control device to increase the positive pressure prevailing in the housing gradually starting from the initial value, for example continuously or stepwise, in order to avoid abrupt pressure changes and accompanying turbulence of the sample.

The device according to the invention for filtering a sample for isolating and/or quantifying a substance to be investigated comprises:
a filter module which has a housing with a first opening forming a sample inlet, a filter, and a second opening which is covered by the filter and forms a sample outlet, wherein the filter is designed to hold back a first portion of the sample and to allow a second portion of the sample to pass through;
a control apparatus at least comprising a pressure control device, wherein the pressure control device is configured to generate a pressure difference between a side of the filter facing the sample inlet and a side of the filter facing away from the sample inlet,
wherein the control apparatus is configured to detect measurement values of a measurement variable which represents the pressure difference and/or a volumetric flow through the filter, and wherein the control apparatus is further configured to compare a series of temporally sequentially detected measurement values of the measurement variable with a predefined reference value and to determine if successively detected measurement values of the measurement variable, over a predefined timespan, are equal to the reference value and/or lie within a predefined range of values around the reference value.

Advantageously, the device is designed to carry out the method according to one of the embodiments described above.

In an advantageous embodiment, the reference value can be the value which the measurement variable assumes when the filter is clogged by the first portion of the sample such that the second portion of the sample and/or a fluid introduced into the housing for pressure generation no longer passes through the filter.

The control apparatus can be identical to the pressure control device. Alternatively, it can comprise additional components besides the pressure control device. The pressure control device can comprise a sensor which is configured to detect measurement values of the measurement variable, for example pressure measurement values. The pressure control device can comprise electronics which are used to evaluate the measurement values, especially the mentioned comparison with the reference value for monitoring the reaching of the termination criterion. However, the control apparatus can also have additional data processing electronics which are connected to the pressure control device and are configured to detect and process the signals of the pressure control device and/or of the sensor. The data processing electronics can be used to monitor the reaching of the termination criterion.

The control apparatus can also comprise a sensor, especially not belonging to the pressure control device, which is integrated in the device in order to detect the measurement values of the measurement variable. In this embodiment, the control apparatus comprises data processing electronics which are connected to the sensor and are configured to process the measurement values of the sensor in order to carry out the method and to determine if successively detected measurement values of the measurement variable, over a predefined timespan, are equal to the reference value and/or lie within a predefined range of values (tolerance interval) around the reference value, and thus if the termination criterion for the filtering method is reached.

The control apparatus can be designed to control the pressure control device in order to carry out the method in a partially automated or fully automated manner. It can simultaneously act as a control system for fully automated execution of the method, for example by controlling a pipetting machine which is used for introducing the sample via the sample inlet into the filter module. The control apparatus can comprise, for example, a computer, a controller or a microcontroller and software executable by the latter and used to carry out the method according to the invention.

The device can advantageously comprise a fluid line opening into the housing of the filter module for introducing a pneumatic fluid, for example compressed air, into the housing. The pressure control device can be configured to regulate an output pressure in the housing to a predefined value by introducing the pneumatic fluid into the housing so as to generate the pressure difference between the side of the filter facing the sample inlet and the side of the filter facing away from the sample inlet. The output pressure can be a positive pressure relative to the atmospheric pressure prevailing in the environment. When the positive pressure is generated, the housing is advantageously closed in a fluid-tight manner except for its second opening covered with the filter.

In one possible embodiment, the device can comprise a collection container for the second portion of the sample, wherein the filter module is connected to the collection container for the second portion of the sample. The collection container can have an opening connectable to the filter module, wherein the second opening, covered by the filter, in the housing of the filter module is aligned with the opening of the collection container when the collection container is connected to the filter module. The collection container can be open to the environment.

The device can comprise a fluid line opening into the collection container for extracting gas, for example air, from the collection container. The pressure control device can be configured to set a predefined output pressure in the collection container, which is a negative pressure relative to the atmospheric pressure prevailing in an environment of the housing, by extracting the gas out of the collection container so as to generate the pressure difference between the side of the filter facing the sample inlet and the side of the filter facing away from the sample inlet. In this embodiment, the filter module is either open to the environment or sealed off from the environment except for the second opening covered by the filter and connected to a fluid line for supplying a pneumatic fluid, for example compressed air. In the latter case, the pressure control device can regulate the pressure both in the housing of the filter module and in the collection container to set the pressure difference across the filter.

The control apparatus can be configured to output a signal to the pressure control device and/or to a user interface of the device if successively detected measurement values of the measurement variable, over a predefined timespan, are equal to the reference value and/or lie within a predefined range of values around the reference value. The signal output to the pressure control device can be a control signal which controls the pressure control device to end the supply of pneumatic fluid into the housing of the filter module. If, as described above, the pressure difference is additionally or alternatively generated by generating a negative pressure in the collection container, the control apparatus can correspondingly output to the pressure control device a control signal which controls the pressure control device to end the extraction of gas from the collection container. The signal output to the user interface can trigger an indication by which a user can recognize that the filtering method carried out by the device has ended or can be ended.

The pressure control device can have a control unit, especially an electropneumatic control unit. In this case, the measurement variable can be an output pressure output by the electropneumatic control unit or a variable correlating with the output pressure, and the reference value can be an input pressure of the control unit or a variable correlating with the input pressure. The input pressure of the control unit can have the value representing the pressure setpoint value to be set in the housing of the filter module or the collection container. If the control unit is an electropneumatic regulator, the mentioned variable correlating with the output pressure can be an output current of the electropneumatic regulator. Accordingly, the mentioned variable correlating with the input pressure can be an input current of the electropneumatic regulator.

In an alternative embodiment, the measurement variable can be a pressure prevailing in the housing of the filter module or a variable dependent on the pressure prevailing in the housing of the filter module, and the reference value can be a pressure setpoint value. Alternatively, the measurement variable can be a pressure prevailing in the collection container for the filtrate or a variable dependent thereon, and the reference value can be a corresponding pressure setpoint value. For detecting the measurement values, the device can comprise a pressure sensor arranged in the housing of the filter module or in the collection container.

In another alternative embodiment, the measurement variable can be a filtrate volumetric flow and/or gas volumetric flow through the filter or a variable representing a filtrate volumetric flow and/or gas volumetric flow through the filter, and the reference value can be a volumetric flow value of zero. In this case, the device can have a flow transducer arranged in the region of the filter, especially on the side of the filter facing away from the sample inlet of the filter module.

The invention is explained in greater detail below based on the exemplary embodiments shown in the figures. Identical parts of the devices shown in the figures are identified by the same reference signs. Shown are:

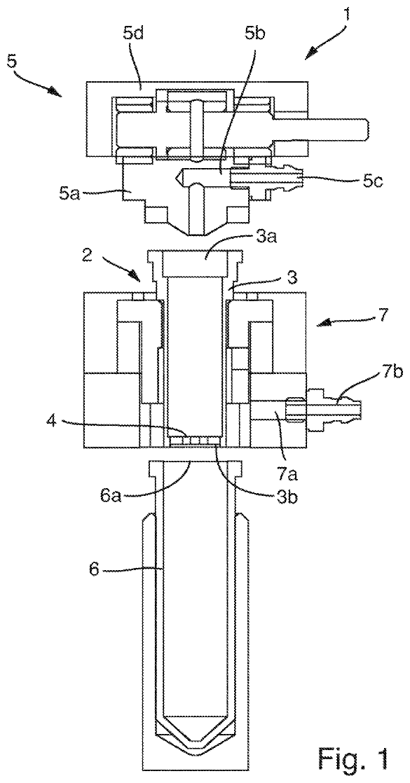

FIG. 1 a schematic longitudinal sectional diagram of the individual components of a filtering device according to a first embodiment;

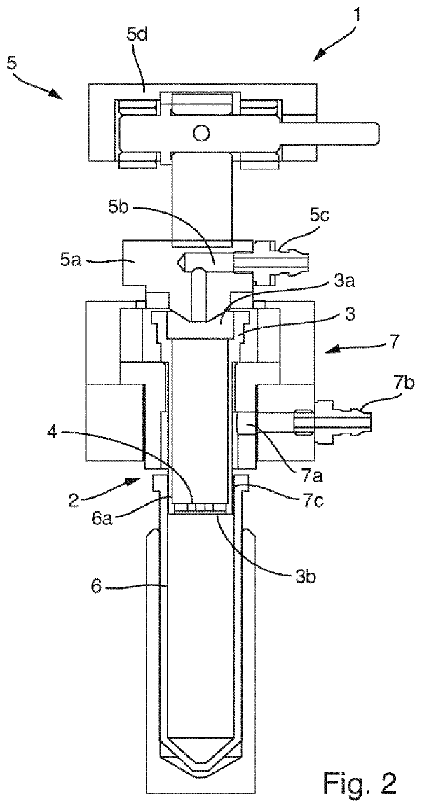

FIG. 2 a schematic longitudinal sectional diagram of the filtering device of FIG. 1 in the assembled state;

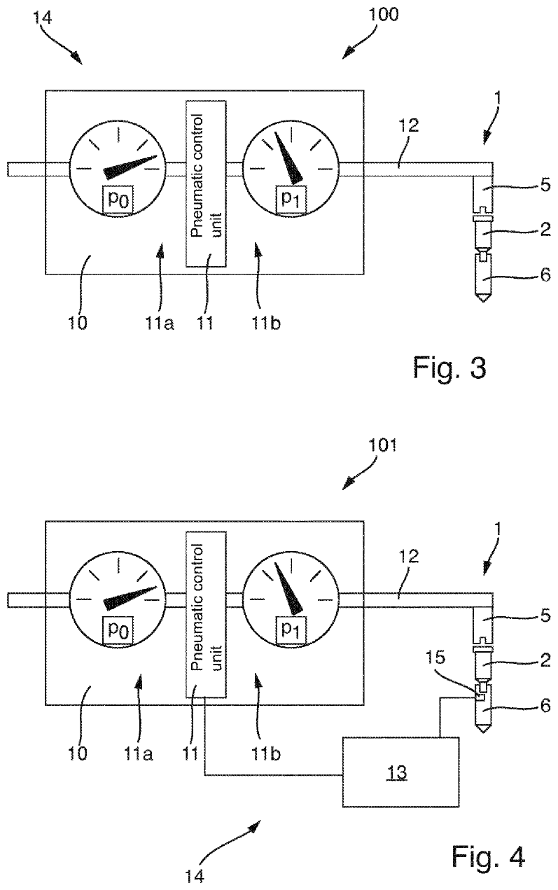

FIG. 3 a schematic diagram of a control system for carrying out a filtering method by means of the device illustrated in FIGS. 1 and 2; and

FIG. 4 a schematic diagram of an alternative control system for carrying out a filtering method by means of the device shown in FIGS. 1 and 2.

FIG. 1 shows a device 1 for carrying out a filtering method for the isolation of a substance to be investigated. The device 1 has multiple modules which can be detachably connected to one another, specifically a filter module 2, a collection container 6, and a pneumatic module 5.

The filter module 2 comprises a housing 3 which is substantially in the form of a cylindrical hollow body, a first opening being arranged at a first end of the cylindrical hollow body and forming a sample inlet 3a. A second opening, which is covered by a filter 4, is arranged at the second end of the cylindrical hollow body opposite the first end. This second opening form a sample outlet 3b. During operation of the device 1, the sample to be filtered is conducted from the sample inlet 3a through the filter 4 and the sample outlet 3b. The filter 4 is configured to hold back a first portion of the sample and to allow a second portion to pass through to the sample outlet 3b. The filter 4 can, for example, have a membrane, a size exclusion filter or a solid which is designed to adsorb the first portion of the sample and which has ducts or pores through which the second portion of the sample can pass through the filter 4. The filter 4 can also be formed by a bed of particles of a solid which adsorbs the first portion of the sample.

The filter module 2 can be connected to the pneumatic module 5 in the region of the sample inlet 3a. The pneumatic module 5 is used to apply a positive pressure to the filter module 2. During operation, the pneumatic module 5 is connected to the filter module 2 via a connecting element 5a such that the first opening of the housing 3 forming the sample inlet 3a is closed by the pneumatic module 5. The connecting element 5a seals tightly with the housing 3 of the filter module 2. The only opening in the housing 3 via which fluid can pass from the interior of the housing 3 into the environment of the filter module 2 is then the sample outlet 3b covered by the filter 4.

The pneumatic module 5 comprises a duct 5b for supplying a pneumatic fluid, for example a gas or gas mixture, into the housing 3 of the filter module 2. The use of compressed air as pneumatic fluid is advantageous since it is readily available. The duct 5b is connected to a pressure control device (not shown in FIG. 1) via a tube nozzle 5c. It can comprise, for example, a pressure regulator, especially an electropneumatic regulator, which conducts the pneumatic fluid into the housing 3 of the filter module via the duct 5b to generate pressure. The pneumatic module 5 further comprises an actuating element 5d which cooperates with the connecting element 5a in order to press it against the sample inlet 3a of the filter module.

The device 1 also includes a collection container 6 having a substantially cylindrical housing which is closed at a first end and has an opening 6a at its opposite second end. The opening 6a can be detachably connected to the outlet-side end of the housing 3 of the filter module 2 so that fluid exiting the sample outlet 3b, especially the second portion of the sample or pneumatic fluid passing through the filter 4, passes into the collection container 6.

The device 1 according to the exemplary embodiment shown here has an extraction device 7 which is detachably connected to the filter module 2. This is optionally present. In the embodiment shown, the extraction device 7 comprises a withdrawal duct 7a, one end of which can be connected via a tube nozzle 7b to a pump or to the aforementioned pressure control device. The other end of the withdrawal duct 7a communicates with the interior of the collection container 6 in the assembled state of the device 1 and during operation of the device.

FIG. 2 shows a schematic longitudinal sectional diagram of the device 1 in the assembled state. The same reference signs designate the same parts of the device. To connect the pneumatic module 5 to the filter module 2, the actuating element 5d is actuated, so that the actuating element 5d exerts a force, directed axially to an imaginary cylinder axis of the filter module 2, on the connecting element 5a in order to press it against the sample inlet 3a. The connecting element 5a thus closes the opening forming the sample inlet 3a in a fluid-tight manner.

The filter module 2 is connected to the collection container 6 in such a way that the sample outlet 3b projects into the collection container 6. The outer wall of the housing 3 of the filter module 2 and the inner wall of the collection container 6 are not closed off from each other in a completely fluid-tight manner. Rather, an opening 7c is formed between the housing 3 and the collection container 6 and communicates with the withdrawal duct 7a of the extraction device 7. In the present exemplary embodiment, the opening 7c is in the form of an annular gap running around the outside of the housing 3 between the housing 3 and the inside of the collection container 6. The annular gap ensures pressure equalization with the environment. A negative pressure can also be generated in the collection container 6 by extracting gas from the collection container 6 via the annular gap by means of the extraction device 7.

During operation of the device 1, a positive pressure is generated in the housing 3 of the filter module 2 by means of the pneumatic module 5. In addition, a negative pressure can optionally be set in the collection container 6 by extracting gas from the collection container 6 via the opening 7c and the withdrawal duct 7a. The positive pressure set in the housing 3 and the negative pressure generated by the extraction device 7 in the region of the sample outlet 3b result in a pressure difference between the side of the filter 4 facing the sample inlet 3a and the side of the filter 4 facing the collection container 6, said pressure difference effecting the transport of the sample through the filter 4. Alternatively, it is also possible not to use the extraction device 7 or to configure the device 1 without the extraction device 7. In this case, ambient pressure (i.e., normal pressure) prevails in the collection container 6 communicating with the environment via the opening 7c. In this case, the pressure difference is established between the housing 3 subjected to positive pressure and the ambient pressure prevailing in the collection container 6.

FIG. 3 schematically shows a device 100 for carrying out a filtering method which consists of the device 1 described in detail with reference to FIGS. 1 and 2 and a control apparatus 14, the control apparatus 14 being formed by the pressure control device 10 in the first exemplary embodiment shown here. The pressure control device 10 is connected via a fluid line 12 to the pneumatic module 5 of the device 1 and is used to set the positive pressure in the housing 3 of the filter module 2. It comprises an electropneumatic control unit 11 having an input side 11a and an output side 11b. The input side 11a is connected or at least temporarily connectable to a pneumatic fluid source, for example a compressed air source. The output side 11b is connected via a fluid line 12 to the duct 5b of the pneumatic module 5. The fluid line 12 can be configured, for example, as a tube which is connected to the tube nozzle 5c of the pneumatic module 5.

A predefined input pressure p₀ is present at the input side 11a of the pneumatic control unit 11. The value of the input pressure p₀ can be set, for example, by a user of the device depending on the medium to be filtered. For the filtration of cells by a size exclusion filter, the predefined input pressure can be 0.5 bar positive pressure, for example. On its output side 11b, the control unit 11 outputs an output pressure p₁, i.e., it sets the output pressure p₁ by supplying pneumatic fluid via the fluid line 12 and the pneumatic module 5 into the housing 3 of the filter module 2. The pneumatic control unit 11 is configured in a manner known per se to regulate the output pressure p₁ to the value of the input pressure p₀. For this purpose, it comprises control electronics which are connected to a valve which selectively blocks or permits transport of pneumatic fluid from the pneumatic fluid source into the fluid line 12. The control electronics are configured to actuate the valve. The pneumatic control unit 11 also comprises a pressure sensor which detects the output pressure p₁ and outputs a signal dependent thereon to the control electronics. On the basis of the signal from the pressure sensor, the control electronics output an output current to the valve to actuate same. This output current correlates with the current output pressure p₁ and is generated by the control electronics on the basis of a comparison with an input current representing the input pressure p₀. The control unit 11 is designed to carry out a pressure correction of the output pressure p₁ by means of the valve until the output pressure p₁ is equal to the input pressure p₀. The pressure control device 10 is designed to generate a positive pressure in the housing 3 of the filter module until the output pressure p₁, over a predefinable period of time, is within a likewise predefinable tolerance value range around the input pressure p₀. Accordingly, the pressure control device 10 is configured to monitor and determine the reaching of this termination criterion using a comparison between the input current and the output current of the electropneumatic control unit 11.

An exemplary embodiment of a method for isolating a substance from a sample by means of the device 100 shown in FIGS. 1 to 3 is described below:

First, the sample is introduced into the housing 3 of the filter module 2 via the sample inlet 3a. In the present example, this can be done manually by pipetting in a specific quantity of the sample via the open sample inlet 3a. The sample inlet 3a is then sealed as described above by attaching the pneumatic module 5. Alternatively, the pneumatic module 5 can comprise a sample supply duct, via which a specific quantity of the sample can be introduced manually or automatically into the housing 3 of the filter module 2. In this case, the pneumatic module 5 does not have to be removed from the filter module 2 each time a further quantity of the sample is introduced into the sample inlet 3a.

In order to conduct the sample through the filter 4, a pressure difference is generated between the interior of the housing 3 and the interior of the collection container 6. This corresponds to setting a pressure difference between the side of the filter 4 facing the sample inlet 3a and the side of the filter 4 facing away from the sample inlet 3a. In the device used in the present exemplary embodiment, this is done by setting a positive pressure in the interior of the housing 3 of the filter module 2 by means of the pressure control device 10 and the pneumatic module 5. As mentioned, a negative pressure can be generated in the collection container 6 at the same time by means of an optional extraction device 7. This is not absolutely necessary for carrying out the method. When the sample is conducted through the filter 4, a first portion of the sample is held back in the filter 4, for example by size exclusion and/or by adsorption on the filter material, while a second portion of the sample passes through the filter 4 and is collected as filtrate in the collection container 6. In the present example, the substance to be isolated by filtration is a constituent of the first portion of the sample held back in the filter 4. However, the method described here can be applied quite analogously if the substance to be isolated is present in the filtrate.

As long as a volumetric flow of the sample or at least of the second portion of the sample is given by the filter 4, the output pressure p₁ of the electropneumatic control unit 11 will be lower than the input pressure p₀. If the output pressure p₁ reaches the value of the input pressure p₀, this is accordingly an indication that the filter 4 is completely closed, so that no fluid, i.e. neither filtrate nor pneumatic fluid, passes through the filter 4 into the collection container 6. If this pressure equality exists for a certain timespan t, which can be determined empirically in advance for a specific embodiment of the device 1, especially a specific filter 4 and a specific sample, a sufficient loading of the filter material with the first portion of the sample and consequently with the substance to be isolated can be assumed. In this case, a termination criterion for the method is reached and the method can be ended.

The reaching of this termination criterion can be monitored and determined on the basis of a comparison of the applied input pressure p₀ with measurement values detected by means of the pressure sensor of the electropneumatic regulating unit 11. It is also possible to provide a pressure sensor which is separate and independent of the pressure control device 10 and which is arranged inside the device 1 in such a way that it detects the pressure prevailing in the interior of the housing 3 of the filter module 2. For example, such a pressure sensor can be arranged in the fluid line 12 or in a line communicating with the fluid line 12. The measurement values detected by this pressure sensor can be compared with the setpoint value to be set by the pressure control device 10, e.g. the input pressure p₀ of the electropneumatic control unit 11a.

For example, the control apparatus 14, which in the present example is formed by the pressure control device 10, can be configured, in order to carry out the comparison, to check whether the successively detected pressure measurement values are within a tolerance interval around the reference value, for example within an interval of +/− 0.01 bar around the reference value of 0.5 bar, over the predefined timespan. If this is the case, the termination criterion is reached.

When the termination criterion is reached, the control apparatus 14 or the pressure control device 10 can end the method by relieving the positive pressure prevailing in the housing 3 of the filter module 2, for example by discharging pneumatic fluid via a ventilation valve. The control apparatus 14 or the pressure control device 10 can also output a signal, for example to a user interface, in order to indicate that the method has ended.

If the output pressure p₁ falls back to a value below the input pressure p₀ or to a value outside the tolerance interval, before the predefined timespan has elapsed, this is an indication that the filter 4 has not yet been completely closed, but only a temporary disturbance of the filtration has occurred. In this case, the method is continued until the termination criterion is reached. The predefined timespan can be a few seconds.

In an alternative method embodiment, values of a variable correlating with the output pressure p₁, for example the output current of the electropneumatic control unit 11, can also be used instead of pressure measurement values in order to monitor the reaching of the termination criterion. In this case, the reference value can be a setpoint value of the variable. In the event that the monitored variable is the output current of the electropneumatic regulating unit 11, the reference value is the input current of the electropneumatic control unit, which correlates with the input pressure p₀.

If the termination criterion is not reached before the entire second portion of the sample supplied in the filter module 2 has passed through the filter 4, the method described up to this point can be continued with a second and possibly further quantities of the sample until the termination criterion is reached. This ensures that the quantity of the substance to be isolated collected in the filter 4 is sufficient for further processing and analysis. In preliminary examinations, it is also possible to determine, by one or more calibration measurements for a given sample type and a given filter type, which quantity of the substance to be isolated is present in the filter 4 when the filter is completely closed by the first portion of the sample. With the calibration data obtained in this way, the portion of the substance to be isolated can be quantified in a sample of unknown composition in that the quantity of the portion of the sample held back in the filter which results in closure of the filter and is determined during the calibration measurement is related to the total quantity of the sample of unknown composition conducted through.

For further processing and analysis of the substance to be isolated, any liquid remaining in the housing 3 can be pipetted off after removal of the pneumatic module 5, and the substance to be isolated can then be obtained from the filter 4, for example by mechanically detaching and/or washing out the substance from the filter 4. The substance can also be eluted directly from the filter 4 by lysis.

FIG. 4 schematically illustrates another exemplary embodiment of a device 101 for filtering a sample with an alternative control system. The device 1 for filtration and the pressure control device 10 in the device 101 are substantially identical to the device 100 according to the first embodiment shown in FIG. 3. The same parts of the devices 100 and 101 are denoted by identical reference signs. A difference between the device 101 shown in FIG. 4 and the device 100 shown in FIG. 3 is that the control apparatus 14 has, in addition to the pressure control device 10, separate data processing electronics 13, which are connected to the pressure control device 10 for communication. In the first exemplary embodiment (FIGS. 1-3), however, the pressure control device 10 substantially assumes the control of the device 100. A further difference consists in that a volumetric flow sensor 15 is arranged in the collection container 6 in the region of the filter 4 and outputs flow measurement values to the data processing electronics 13 of the control apparatus 14. The data processing electronics 13 are designed to compare the obtained flow measurement values with a reference value of zero. A method carried out by means of the device shown in FIG. 4 can be ended if a volumetric flow through the filter 4 of substantially zero is present over a predefined timespan. This is an indicator that the filter 4 is clogged by the first portion of the sample so that the second portion of the sample or pneumatic fluid no longer passes through the filter 4. The data processing electronics 13 are therefore designed to monitor this termination criterion. The reaching of the termination criterion is detected by the data processing electronics 13 when successive measurement values of the volumetric flow over a predefined timespan lie within a predefined tolerance value interval around the reference value. The data processing electronics 13 are further configured, when this termination criterion is detected, to output a control signal to the pressure control device 10 to end application of the output pressure p₁. At the same time, it can be configured to output, via a user station, a signal indicating that the method is ended. Otherwise, the filtering method, the processing of the substance to be isolated and optionally a quantification of the substance can take place in the same way as described for the exemplary embodiment of FIGS. 1 to 3.

Many variants and alternative embodiments of the exemplary embodiments described here are conceivable for the person skilled in the art and are included in the invention described here. For example, a pressure difference between the side of the filter facing the sample inlet and the side facing away from the sample inlet can be generated by regulating a negative pressure in the collection container instead of a positive pressure in the filter module. In this case, the collection container can be sealed off from the environment and connected to a pressure regulator which sets a predefinable negative pressure in the collection container. In this case, the housing of the filter module is connected via a pressure equalization line, for example, to the environment of the device or to a pneumatic fluid reservoir. In this embodiment, measurement values of the pressure prevailing in the collection container are detected and compared with a setpoint value of the negative pressure to be set in the collection container. In this case, the termination criterion is reached when the detected pressure measurement values are within a tolerance interval around the setpoint value over a predefined timespan.

1-17. (canceled)

18. A filtering method for isolating and/or quantifying, from a sample, a substance to be investigated, the method comprising:
providing a filter module, including:
a housing having a first opening forming the sample inlet and a second opening forming a sample outlet; and
a filter covering the second opening, wherein the filter is designed to hold back a first portion of the sample and to allow a second portion of the sample to pass through;
introducing via the sample inlet a first quantity of the sample into the filter module;
conducting the sample from the sample inlet through the filter and the sample outlet by applying a pressure difference between a side of the filter facing the sample inlet and a side of the filter facing away from the sample inlet, wherein the second portion of the sample leaves the filter module through the sample outlet as a filtrate;
detecting while the sample is being conducted from the sample inlet through the filter to the sample outlet a series of temporally sequentially recorded measurement values of a measurement variable which represents the pressure difference and/or a volumetric flow through the filter;
comparing the measurement values to a predefined reference value of the measurement variable; and
ending the filtering method when successively detected measurement values of the measurement variable, over a predefined timespan, are equal to the reference value and/or lie within a predefined range of values around the reference value.

19. The method according to claim 18,
wherein the reference value is a value which the measurement variable assumes when the filter is clogged by the first portion of the sample such that the second portion of the sample and/or a fluid introduced into the housing for pressure generation no longer passes through the filter.

20. The method according to claim 18, further comprising:
after the filtering method has ended, obtaining the substance to be investigated from the first portion of the sample held back in the filter module by the filter as filter cake.

21. The method according to claim 18, further comprising:
if the second portion of the sample completely leaves the filter module before successively detected measurement values of the measurement variable, over the predefined timespan, are equal to the reference value and/or lie within the predefined range of values around the reference value, introducing a second quantity of the sample via the sample inlet and conducting the sample from the sample inlet through the filter and the sample outlet, and repeating these steps until successively detected measurement values of the measurement variable, over the predefined timespan, are equal to the reference value and/or lie within the predefined range of values around the reference value.

22. The method according to claim 18,
wherein the pressure difference is applied by means of a pressure control device cooperating with the filter module to set a pressure prevailing in the housing.

23. The method according to claim 18,
wherein the measurement variable is a pressure prevailing in the housing of the filter module or a variable dependent on the pressure prevailing in the housing of the filter module, and the reference value is a pressure setpoint value.

24. The method according to claim 22,
wherein the pressure control device includes a control unit, and wherein the measurement variable is an output pressure output by the control unit or a variable correlating with the output pressure, and the reference value is an input pressure of the control unit or a variable correlating with the input pressure.

25. The method according to claim 18,
wherein the measurement variable is a filtrate volumetric flow and/or air volumetric flow through the filter or a variable representing a filtrate volumetric flow and/or air volumetric flow through the filter, and the reference value is a volumetric flow value of zero.

26. The method according to claim 18,
wherein the substance to be investigated is a particle type present in the sample, a cell type, cell constituents, or a molecular or macromolecular substance.

27. The method according to claim 18,
wherein the pressure difference is applied by means of a pressure control device cooperating with the filter module to set a pressure prevailing in the housing, and wherein the positive pressure prevailing in the housing is reduced by means of the pressure control device to remove the filter cake and/or before a second quantity of the sample is applied.

28. A device for filtering a sample for isolating and/or quantifying a substance to be investigated, the device comprising:
a filter module, including:
a housing having a first opening forming a sample inlet;
a filter; and
a second opening that is covered by the filter and forms a sample outlet,
wherein the filter is designed to hold back a first portion of the sample and to allow a second portion of the sample to pass through; and
a control apparatus, including:
a pressure control device,
wherein the pressure control device is configured to generate a pressure difference between a side of the filter facing the sample inlet and a side of the filter facing away from the sample inlet,
wherein the control apparatus is configured to detect measurement values of a measurement variable which represents the pressure difference and/or a volumetric flow through the filter, and
wherein the control apparatus is further configured to compare a series of temporally sequentially detected measurement values of the measurement variable with a predefined reference value and to determine if successively detected measurement values of the measurement variable, over a predefined timespan, are equal to the reference value and/or lie within a predefined range of values around the reference value.

29. The device according to claim 28, further comprising:
a fluid line opening into the housing of the filter module for introducing a pneumatic fluid into the housing,
wherein the pressure control device is configured to regulate an output pressure in the housing to a predefined value by introducing the pneumatic fluid into the housing.

30. The device according to claim 28,
wherein the control apparatus is configured to output a signal to the pressure control device and/or to a user interface of the device if successively detected measurement values of the measurement variable, over a predefined timespan, are equal to the reference value and/or lie within a predefined range of values around the reference value.

31. The device according to claim 28,
wherein the pressure control device includes an electropneumatic control unit.

32. The device according to claim 31,
wherein the measurement variable is an output pressure output by the control unit or a variable correlating with the output pressure, and the reference value is an input pressure of the pressure regulator or a variable correlating with the input pressure.

33. The device according to claim 28,
wherein the measurement variable is a pressure prevailing in the housing of the filter module or a variable dependent on the pressure prevailing in the housing of the filter module, and the reference value is a pressure setpoint value.

34. The device according to claim 28,
wherein the measurement variable is a filtrate volumetric flow and/or air volumetric flow through the filter or a variable representing a filtrate volumetric flow and/or air volumetric flow through the filter, and the reference value is a volumetric flow value of zero.
